(19) United States
(12) Patent Application Publication
(10) Pub. No.: US 2003/0066877 A1
(43) Pub. Date: Apr. 10, 2003

(54) Dynamic electronic business card system

(75) Inventors: M. Daniel Howard, San Diego, CA (US); Evan P. Ziegeweid, Manhattan Beach, CA (US); Andrew V. Cianciotto, West Hollywood, CA (US)

Correspondence Address: FRANK G MORKUNAS, 7750 DAGGET ST, SUITE 203, SAN DIEGO, CA, 92111

(73) Assignee: WEBKEYZ, INC.

(21) Appl. No.: 09/950,746

(22) Filed: Sep. 10, 2001

(51) Int. Cl. G06K 5/00

(52) U.S. Cl. 235/380

(57) ABSTRACT

An electronic business card system (EBC) wherein access to information specific to a principal and one or more specific agents of the principal is through the Internet. Such access is through a suitable accessing medium, linking or interfacing the user to the information contained on a data base. The accessing medium may be a CD-ROM type EBC. The principal or agent may change their respective information via the Internet without affecting the accessing medium or the link to the data base. By this system, information of the principal and the agent may be kept current at all times without requiring new EBCs to be made or re-recordable EBCs to be re-recorded.

### CROSS REFERENCES TO RELATED APPLICATIONS

Not applicable.

### STATEMENT REGARDING FEDERALLY-SPONSORED RESEARCH OR DEVELOPMENT

Not applicable.

### BACKGROUND OF THE INVENTION

This present invention relates to an improvement in electronic business cards, and more particularly to such business cards linkable to, or interfacing with, the Internet and containing such links to, or interfaces with, up-to-date business information relative to the respective business.

In this regard, the use of the computer, in any form, has grown exponentially over the recent years. The global information system known as the Internet has grown even quicker. More and more businesses are entering the virtual world of the Internet to reach a vast world-wide consumer and customer base. Internet presence is paramount to the success and survival of many businesses. Old methods of doing business are intertwining with the new; i.e., Internet. Contact with clients/customers, whether face-to-face, phone-to-phone, or person-to-business (whether personally, via a pre-recorded transaction, or via the Internet) and conveying information to them remain fundamental to all businesses.

In the past, as well as currently, employees (agents) of businesses print and dispense business cards bearing the agent's identifying data and means of contact (mailing address, phone numbers, e-mail address, company name, and other pertinent data the agent wishes to convey). The more information which can be placed on a business card, the more likely a contact will become a customer or client. The advent of magnetic storage strips/readers and compact disks (and mini- or micro-compact disks) has permitted an agent (or principal) to place more and more information (including, but not limited to, video presentations, audio presentations, textual presentations, and any combination thereof; collectively referred to herein as information) on a business card having, for instance, but not limited to, a magnetic (recordable and readable) strip thereon or a business card fashioned from a compact disk (CD). With any such system for business cards (traditional card, magnetic strip, or CD), as the information thereon changes (i.e., identifying data, contact means, and presentation updates), the agent or principal should change the business card, alter the magnetic strip, or burn another CD otherwise a point of contact may be lost or the information inaccurate. All this can come at high costs which adversely affect the principal's profit line and the agent's overall net income. With the global market ever widening and mergers and acquisitions on the rise, business information changes are seemingly routine.

There are several ‘electronic’ business cards (EBCs) in existence but none is as versatile or dynamic or as inter active as is the present invention. The present invention envisions a means of maintaining an electronic business card current at all times regardless of address changes (agent or business), phone number changes, name changes, operations changes, policy changes, presentation modifications, and the like.

Accordingly, several objects and advantages of this invention are to:

a. permit volumes of information to be stored on an electronic business card (EBC) and, as changes to the business occur, not require the creation of a new EBC;

b. permit an agent (of the business) to make changes relevant to the agent on an EBC without affecting information of the principal and without requiring the creation of a new EBC;

c. permit the principal (of the business) to make changes relevant to the principal on an EBC associated with the business and/or with an agent with or without affecting information of the agent and without requiring the creation of a new EBC; and

d. maintain an EBC system which is current at all times.

The foregoing has outlined some of the more pertinent objects of the present invention. These objects should be construed to be merely illustrative of some of the more prominent features and applications of the intended invention. Many other beneficial results can be attained by applying the disclosed invention in a different manner or by modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### BRIEF SUMMARY OF THE INVENTION

The above-noted problems, among others, are overcome by the present invention. Briefly stated, the present invention contemplates an electronic business card system (EBC) wherein a principal has a link to the principal's on-line data base on an accessing medium (such as, but not limited to, a compact ROM disk business card) which is usable by the principal, by an agent of the principal, or by a client/customer user. A principal's information (P-INFO) is stored on the data base in a specific storage location for the principal (P-STORAGE). Within P-STORAGE are the principal's identity (P-ID) and a password for the principal (P-PW). Each agent of the principal can add to P-STORAGE information specific to that agent (A-INFO) in an agent folder (A-STORAGE) identifiable to that specific agent which is created when that agent logs into the principal's data base using a specific set of parameters devised by the principal for that purpose. When an agent uses the set of parameters, an agent identity (A-ID) is established, A-STORAGE is created therefor, and a password for the agent (A-PW) is generated by the agent. The establishing agent may order one or more EBCs with A-ID and a connecting medium (such as a link to, or interface with) to P-STORAGE thereon. Such connecting may be, by way of example only and not by way of limitation; through, by, or with links; through, by, or with hyperlinks; through, by, or with browsers; or through, by, or with a direct interface (i.e., a direct connection between user and applicant's server capable of transmitting data/information [reference character 40 in FIG. 1). A customer using the accessing medium will connect (via a direct link to or interface with or any similar means described above) with the principal's data base and, in particular, be given viewing access to P-INFO and A-INFO within P-STORAGE and A-STORAGE, respectively; A-INFO being specific to the agent creating the EBC to distribute to a customer to use.

As information relative to the principal (P-INFO) or to the specific agent (A-INFO) changes, or either party desires to make a change to their respective information, all they need do is enter the data base using their respective identity (P-ID or A-ID) and password (P-PW or A-PW, respectively) and modify such information contained therein (P-INFO or A-INFO, respectively). Such modifications do not affect the accessing medium or the link to, or interface with, the principal's data base and no new EBCs need be created and re-distributed to customers. The information on the data base is as current as the motivation of the provider of the information dictates it to be. The expense associated with creating a new EBC and the time wasted in re-distributing it are eliminated.

The foregoing has outlined the more pertinent and important features of the present invention in order that the detailed description of the invention that follows may be better understood so the present contributions to the art may be more fully appreciated. Additional features of the present invention will be described hereinafter which form the subject of the claims. It should be appreciated by those skilled in the art that the conception and the disclosed specific embodiment may be readily utilized as a basis for modifying or designing other structures and methods for carrying out the same purposes of the present invention. It also should be realized by those skilled in the art that such equivalent constructions and methods do not depart from the spirit and scope of the inventions as set forth in the appended claims.

### BRIEF DESCRIPTION OF THE DRAWINGS

For a fuller understanding of the nature and objects of the invention, reference should be had to the following detailed description taken in conjunction with the accompanying drawings in which:

FIGS. 1 and 2 comprise a flow chart depicting the electronic business card (EBC) system of the present invention.

### DETAILED DESCRIPTION OF THE INVENTION

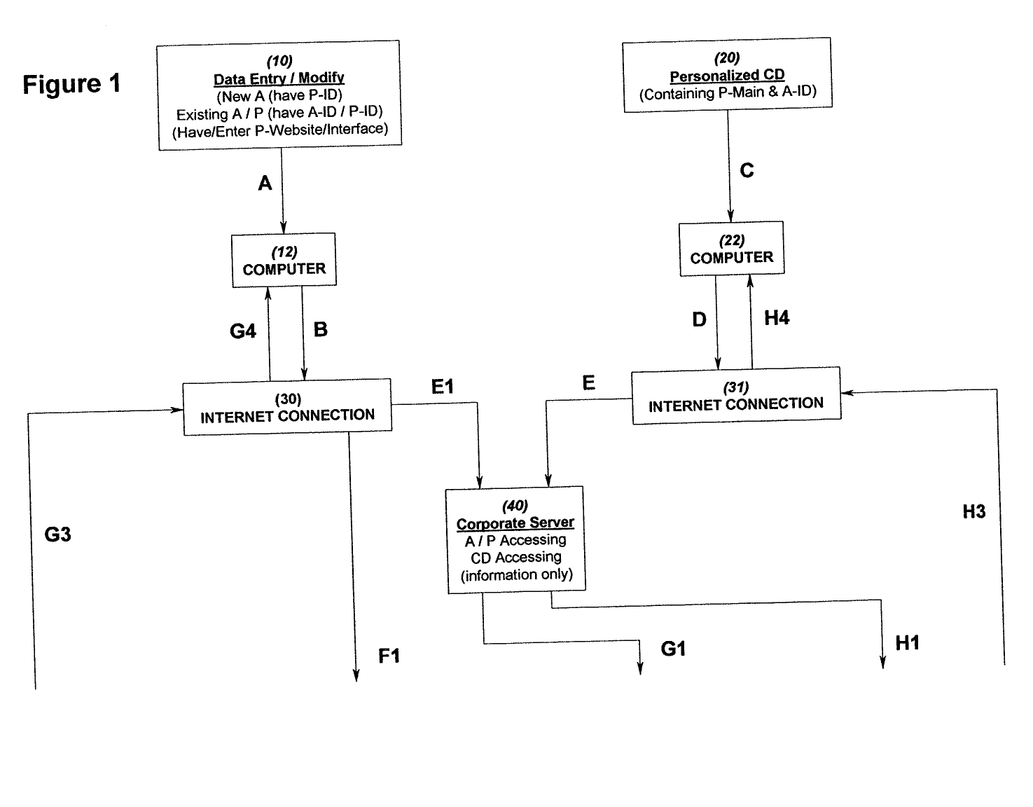

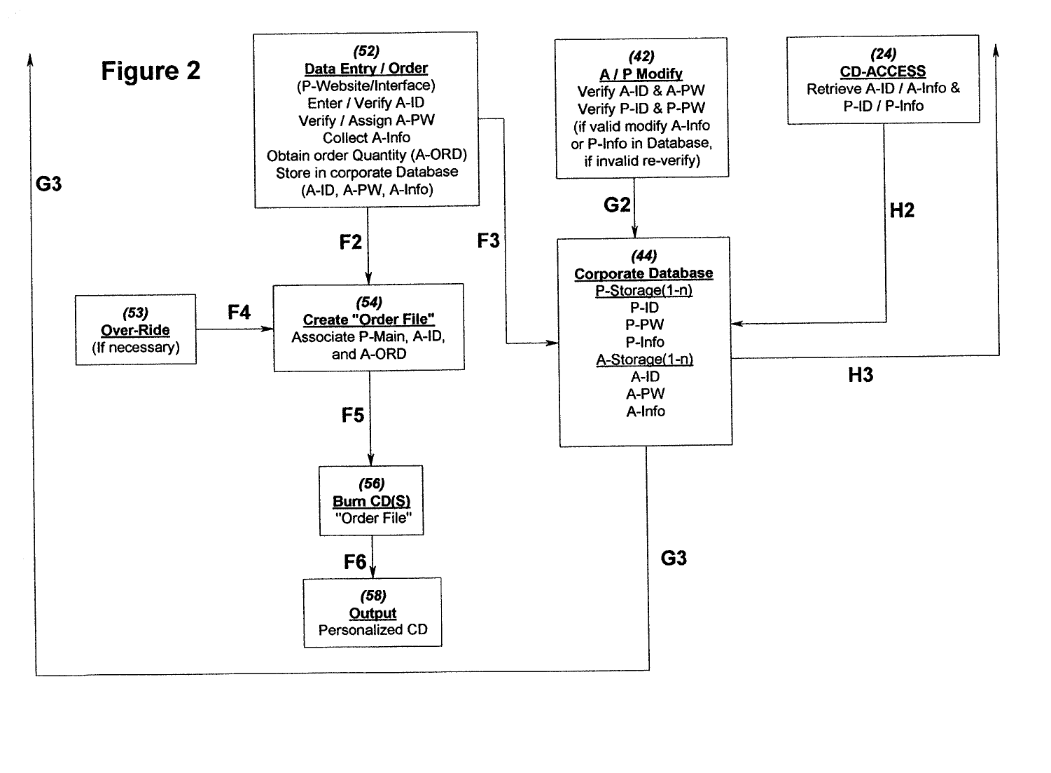

Referring now to the drawings in detail, FIGS. 1 and 2 generally designates an electronic business card (EBC) system constructed and applied in accordance with a preferred embodiment of the present invention.

It is envisioned that a principal, such as a business entity, would have a great need for utilizing EBCs which contain a great deal of information on them in a variety of virtually limitless forms and formats (such as, but not limited to, general information, specific information as to the principal, general and specific information related to a specific agent of the principal, graphics, video presentations, audio presentations, and the like). Such information is prepared and recorded onto the EBC. For administrative clarity and convenience, the term ‘burn’, and variations thereof, will be used to reflect a recording or storing of information onto the EBC and, as such, encompasses all forms of such storing and recording onto any type of EBC whether such be onto a CD, a magnetic tape, a magnetic strip, and the like (these terms as used throughout are not meant as a limitation to CDs). If, however, changes are necessary (for instance, as the principal's or agent's address or contact means changes) the EBC (if re-writable) generally has to be ‘re-burned’ with the new information or, if not re-writable, a completely new EBC must be created (‘new burn’). The present invention eliminates the need for a re-burning an existing EBC or burning a new EBC. The EBC is the accessing medium of this system which, after inserting the EBC into a compatible device with access to the Internet, (1) directs or links the user to the site or location such information is contained or (2) interfaces with the site or location such information is contained or (3) sends a request for data/information to a server and responds to the interface that does not change; and, then in each case, permits viewing of that data/information.

Utilizing the scope of this present invention, a principal would first have placed on the corporate data base 44 a storage location (whether such be called a folder, a directory, a record, etc.; is immaterial as what is important is the ability to store, retrieve, and modify data/information so stored) related to that principal (P-STORAGE). The corporate data base 44 is managed by any suitable manager and is accessible via the Internet through the corporate server 40. A plurality of different principals may have their own P-STORAGE placed onto the corporate data base 44. The number or principals containable within the corporate data base 44 is limited only by the storage capacity thereat, which may comprise a plurality of storage medium to which additional storage medium may be added rendering the corporate data base virtually limitless. P-STORAGEs may range from 1-n. Each P-STORAGE is identified to one specific principal by that specific principals identity (P-ID). A password is established for that specific principal (P-PW) which is identifiable to the P-ID. The principal chooses how many employees of the principal have access to the P-PW. The principal decides what information specific to that principal (P-INFO) is to be included and placed onto the corporate data base 44. The type, format, and size of P-INFO is virtually unlimited. It may consist of, but not be limited to, video presentations, textual matter, audio material, or any combinations thereof in any means of presentation (collectively referred to herein as information).

The principal may have one or more employees or agents working directly for the principal or working indirectly for the principal as independent contractors. For administrative clarity, the term agent herein will apply to all types of relationships a person has with the principal which brings business or income to the principal. A set of parameters is established for a specific agent to identify with a specific principal and to create an agent identity (A-ID) specific to that agent and a folder or directory (i.e., storage location referred to as A-STORAGE) identifiable to that A-ID. The set of parameters could be, but are not limited to, contact information {name, address, phone number, e-mail address, etc.}, graphic schemes {colors, buttons navigation interfaces, audio files, video files, picture files, product promotions, demos, calendars, company newsletters, sales sheets, specifications, etc.}, passwords, corporate identifications, secure information transactions, and the like.

Once an A-ID and A-STORAGE is established, that specific agent may create a password (A-PW) identifiable to that specific agent's A-ID. With the A-ID and the A-STORAGE created, the agent may enter information specific to that agent (A-INFO) in the corporate data base 44. Such information may be information similar to that of the principal's but specific to the agent; i.e., general information about the agent, specific information about the agent (qualifications, education, experience, etc.), contact means for the agent (phone number, address, e-mail, etc.), textual information about the agent, videos crafted by the agent, audio information created by the agent, directional links to, or direct interface with, other general or specific information, and any combinations thereof.

P-STORAGE resides in the corporate data base 44. P-STORAGE contains P-ID, P-INFO, P-PW, the instructional set of parameters for the agents, and, when established, A-ID associated with A-STORAGE. A separate A-STORAGE (from 1-n), associated with its respective A-ID, is contained within P-STORAGE for every agent of the principal. Each A-STORAGE is a separate storage location or locations within a computer storage medium which location or locations are identified to its respective P-STORAGE and retrievable therefrom (it must be understood that a ‘location’ for storage of data/information in a computer does not generally mean all such data/information are clustered in one spot; they may, and generally are, scattered throughout various locations on the computer storage medium but, to a user, seem to be in one location and are retrievable as thought they seemingly were). Each A-STORAGE contains within it A-INFO and A-PW relative to the respective specific agent creating/entering it. All the information, identities, and passwords may be placed on the corporate data base 44 at a physical location away from the actual physical location of the server housing the corporate data base 44 via the Internet; or, such may be manually entered into the server at its physical location. What the system of the present invention envisions is Internet use after a set of directional instructions (P-MAIN), having links to or interfaces with P-STORAGE, are prepared for the principal for use by its agents/customers.

P-MAIN consists of, but is not limited to, a suitable connecting medium such as an interface between an Internet user and P-INFO or a link there between.

Typically, and following directional flow arrows A, B, and F1, a specific agent of a specific principal would use a computer 12, via an Internet connection 30 to access a website 52 associated with the specific principal the purpose of which is to enter data specific to that agent, to modify data specific to that agent 10, or to place an order for one or more EBCs 52. An agent could accomplish this by having access to P-MAIN or to a specifically designated website or address.

An agent of the principal who has not established an A-ID or an A-STORAGE on P-STORAGE would typically create an A-ID unique to that agent using the parameter set established by the principal. If the agent follows the parameter set, an A-ID and an A-STORAGE for that agent are established in that principal's P-STORAGE in the corporate data base 44 (following directional flow arrow F3 from the Date Entry/Order block 52; directional flow arrows G3 and G4 represent feedback to the agent of that agent's entries of parameters sets or information or both and whether such are being accepted or rejected). A rejection would occur if the parameter set established by the principal is not followed or is incorrectly entered by the agent. If the parameter set established by the principal is followed and is correctly inputted by the agent, the A-ID is accepted and an A-STORAGE is created for that agent. At this point the agent may (and should) establish a password (A-PW) specific to that entering agent and may enter any and all information specific to that agent (A-INFO). A-INFO will be stored in that entering agent's A-STORAGE which resides in P-STORAGE (identified with/to that P-STORAGE) of the specific principal associated with that specific agent. Also at this point, that agent may order one or more EBCs 54 (directional flow arrow F2). Once placed, the EBCs are ‘burned’ 56 and the order outputted 58 for delivery to the agent (directional flow arrows F5 and F6 pertain). At any time before the ‘burn’ 56 an agent may override the order and make changes to it 53 (directional flow arrow F4 relates). The ‘burn’ process 56 illustrates that a compact disk (CD) is the medium. It should be understood that any recordable storage medium, external or internal, suited for the intended purpose will suffice and illustrating a CD or using the term ‘burn’ and variations thereof (as discussed earlier) should not be construed as a limitation to the present invention but only one of many possible examples.

What is burned onto the medium is P-MAIN, directional links or interfaces (connecting medium) for a user of the storage medium to P-STORAGE and P-INFO, and an association to the specific agent (A-ID) ordering the medium with links or direct interfaces to that agent's A-INFO. P-INFO also is a specifically organized program created for a principal which highlights or showcases messages, goods, services, training tutorials, related media articles, promotions, partners, co-branding, and the like. It is limited only by the imagination, desires, and needs of the principal.

An agent who has previously established that agent's A-ID, A-STORAGE, A-PW, and A-INFO could later access the corporate data base 44 thru the corporate server 40 via the Internet connection 30 and be given the opportunity to modify A-INFO 42 (directional flow arrows A, B, E1, G1, and G2 pertain). The accessing agent may gain access to A-INFO for modification purposes provided an accurate A-ID and associated A-PW for that agent is entered and verified as correct. If not, the user will be directed to try again or will only be provided viewing access to P-INFO and A-INFO. If the A-ID and A-PW are verified correct, that agent gains access to A-INFO and may modify A-INFO. This is extremely important when that agent's phone number has changed, or address has changed, or qualifications have been enhanced, and the like. Rather than create and ‘burn’ new EBCs or ‘re-burn’ re-writable existing EBCs which have been previously created by an agent, the agent merely accesses A-INFO and enters changes on the corporate data base 44 leaving the EBC unaltered. In this system, information relative to that agent, and all agents, of the specific principal relative to those agents, remains as current as the agent makes changes (which could be nearly instantaneous with the physical change taking place). Directional flow arrow G2, G3, and G4 represent on-line feed back to the agent.

What has been described above for an agent initially entering the corporate data base 44 (to establish an A-ID and A-STORAGE for that agent, and an A-PW for that agent, and to enter A-INFO for that agent) and a previously-established agent entering the corporate data base 44 for modification of A-INFO also pertains to the principal who is in need of entering information or making changes to their P-INFO. The principal uses P-ID and P-PW which, if verified, permits access to P-INFO for modification. The principal may also modify A-INFO similarly by using P-ID, P-PW, and A-ID, which if verified as correct, grants access to A-INFO for modification. This capability accords the principal some quality control and standards of taste and professionalism as deemed appropriate by the principal.

Principals and agents may order one or more EBCs, specifically personalized to them, for distribution to customers/clients (users). Each personalized EBC contains the link (P-MAIN associated to a specific A-ID) to the corporate server 40, via the Internet 31, and ultimately to the corporate data base 44 identifiable to the specific principal (P-STORAGE and P-INFO) and to the specific agent (initially creating the EBC) and that agent's A-INFO (directional flow arrows C, D, E, H1, H2, H3, and H4 pertain). Each user would typically place the personalized EBC 20 into a suitable Internet-connecting device such as, but not limited to, a computer 21. P-MAIN directs the Internet connection 31, via the corporate server 40, to the access point 24. At this point, since P-MAIN associates with P-STORAGE and associates with the A-ID of the agent creator of the personalized EBC, information relative to the respective P-ID and A-ID (P-INFO and A-INFO, respectively) are retrieved from the corporate data base 44 and displayed to the user. Such information will be as current as the diligence, and motivation, of the respective principal and agent dictates.

The present disclosure includes that contained in the present claims as well as that of the foregoing description. Although this invention has been described in its preferred forms with a certain degree of particularity, it is understood that the present disclosure of the preferred forms has been made only by way of example and numerous changes in the details of construction and combination and arrangement of system components and method steps may be resorted to without departing from the spirit and scope of the invention. Accordingly, the scope of the invention should be determined not by the embodiment[s] illustrated, but by the appended claims and their legal equivalents.

The invention claimed is:

1. An electronic business card system comprising:
(a) an accessing medium comprising means for directing a user, via a global computer network, to information to a specific principal (P-INFO) on said global computer network; and
(b) means for a specific principal to modify said P-INFO without modifying said accessing medium such that said P-INFO remains current to said user of said accessing medium.

2. The system as defined in claim 1 further comprising a main database accessible via said accessing medium, said main database comprising one or more P-STORAGE wherein each one of said one or more P-STORAGE respectively corresponds to said specific principal.

3. The system as defined in claim 2 wherein each of said one or more P-STORAGE comprises a principal's identity (P-ID) specific to said specific principal for identifying said specific principal, and contains said P-INFO therein for said specific principal corresponding to said P-ID for said specific principal.

4. The system as defined in claim 3 wherein each of said one or more P-STORAGE further comprises a password (P-PW) specific to said P-ID wherein said specific principal may modify said P-INFO by accessing said main database with said P-ID, by entering said P-PW into said main database and, if verified, said specific principal is granted access to said P-INFO for modification.

5. The system as defined in claim 2 wherein each one of said one or more P-STORAGE comprises one or more agent folder (A-STORAGE) and a respective specific agent identity (A-ID) to each one of said one or more A-STORAGE, said A-ID and said A-STORAGE corresponding to a specific agent of said specific principal and that principal's respective said P-ID and said P-STORAGE.

6. The system as defined in claim 5 further comprising a set of parameters established by said specific principal for creating said A-ID and said A-STORAGE for said specific agent identifiable to said specific principal, said A-INFO and said A-STORAGE stored in said P-STORAGE.

7. The system as defined in claim 6 wherein each of said one or more A-STORAGE comprises an agent password (A-PW) specific to said A-ID and further comprises information specific to said specific agent (A-INFO).

8. The system as defined in claim 7 further comprises means for said specific agent to modify said A-INFO without modifying said accessing medium or said P-INFO by accessing said main database with said A-ID, by entering said A-PW into said main database and, if verified, said specific agent is granted access to said A-INFO for modification.

9. The system as defined in claim 7 further comprising means for said specific principal to modify said A-INFO without modifying said accessing medium or said P-INFO.

10. The system as defined in claim 9 wherein said specific principal may modify said A-INFO by accessing said main database with said P-ID, by entering said A-ID and said P-PW into said main database and, if verified, said specific principal is granted access to said A-INFO for modification.

11. The system as defined in claim 2 wherein said accessing medium comprises an external storage medium.

12. The system as defined in claim 11 wherein said means for directing a user to said P-INFO comprises a connecting medium to a specific principal (P-MAIN).

13. The system as defined in claim 12 wherein P-MAIN comprises a principal's identity (P-ID) specific to said specific principal.

14. The system as defined in claim 13 further comprising a set of parameters for creating a specific agent identity (A-ID) for a specific agent, said A-ID identifiable to said specific principal, and for creating an agent password (A-PW) unique to said A-ID and identifiable to said A-ID and P-ID.

15. The system as defined in claim 14 wherein each of said one or more P-STORAGE further comprises a password (P-PW) specific to said P-ID wherein said specific principal may modify said P-INFO by accessing said main database with said P-ID, by entering said P-PW into said main database and, if verified, said specific principal is granted access to said P-INFO for modification.

16. The system as defined in claim 14 wherein each one of said one or more P-STORAGE comprises one or more agent folder (A-STORAGE) relative to said A-ID, each said A-STORAGE corresponding to a specific agent of said specific principal and that principal's respective said P-ID and said P-STORAGE and further comprising therein information specific to said specific agent (A-INFO).

17. The system as defined in claim 16 further comprises means for said specific agent to modify said A-INFO without modifying said external storage medium or said connecting medium or said P-INFO by accessing said main database with said A-ID, by entering said A-PW into said main database and, if verified, said specific agent is granted access to said A-INFO for modification.

18. The system as defined in claim 16 further comprising means for said specific principal to modify said A-INFO without modifying said external storage medium or said connecting medium or said P-INFO.

19. The system as defined in claim 18 wherein said specific principal may modify said A-INFO by accessing said main database with said P-ID, by entering said A-ID and said P-PW into said main database and, if verified, said specific principal is granted access to said A-INFO for modification. more external storage medium contains said P-INFO and said A-ID.

20. A method of maintaining a dynamic electronic business card system, via a global computer network, comprising the steps of:
(a) maintaining a main database accessible via an ACCESSING MEANS for accessing said main database;
(b) placing on said main database into a specific folder identifiable to said specific principal (P-STORAGE),
(1) information relative to said specific principal (P-INFO),
(2) parameters relative to said specific principal's agents such that an agent folder (A-STORAGE) specific to a specific agent may be created by one or more specific agents of said specific principal by utilizing said parameters,
(3) said specific principal's identity (P-ID), and
(4) a password for said specific principal (P-PW);
(c) providing a means for linking (LINKING MEANS) on said ACCESSING MEANS for directing a user to said P-INFO; and
(d) providing a means for said specific principal to modify said P-INFO without modifying said ACCESSING MEANS or said LINKING MEANS.

21. The method as defined in claim 20 wherein said means for said specific principal to modify said P-INFO without modifying said ACCESSING MEANS or said LINKING MEANS comprises the step of said specific principal using said ACCESSING MEANS with said P-ID to connect to said main database, enter said P-PW, and if verified, to begin modifying said P-INFO.

22. The method as defined in claim 20 further comprising the step of providing access to said P-STORAGE for said specific agents of said specific principal for the purpose of said specific agents establishing a specific agent identity (A-ID) and creating said A-STORAGE associated with said A-ID, for establishing an agent password (A-PW) for said A-ID, and for placing information specific to said specific agent (A-INFO) into said A-STORAGE.

23. The method as defined in claim 22 further comprising the step of providing a means for said specific agent to modify said A-INFO without modifying said P-INFO or said ACCESSING MEANS or said LINKING MEANS.

24. The method as defined in claim 23 wherein said means for said specific agent to modify said A-INFO without modifying said P-INFO or said ACCESSING MEANS or said LINKING MEANS comprises the step of said specific agent using said ACCESSING MEANS with said A-ID to connect to said main database, enter said A-PW, and if verified, to begin modifying said A-INFO.

25. The method as defined in claim 22 further comprising the step of providing a means for said specific principal to modify said A-INFO without modifying said P-INFO or said ACCESSING MEANS or said LINKING MEANS.

26. The method as defined in claim 25 wherein said means for said specific principal to modify said A-INFO without modifying said P-INFO or said ACCESSING MEANS or said LINKING MEANS comprises the step of said specific principal using said ACCESSING MEANS with said P-ID to connect to said main database, enter said A-ID, enter said P-PW, and if verified, to begin modifying A-INFO.

27. The method as defined in claim 20 wherein said ACCESSING MEANS comprises an external storage medium.

28. The method as defined in claim 27 further comprising the steps of permitting said specific agent to order, via said global computer network, said external storage medium linkable to said P-INFO, by connecting to said main database; establishing or verifying said specific agent's identity; establishing or verifying said specific agent's password; entering, modifying, or verifying said specific agent's information; placing an order for one or more external storage medium.

29. The method as defined in claim 28 further comprises the step of verifying or modifying said order.

30. An electronic business card system comprising:
(a) an external storage medium comprising means for directing a user, via a global computer network, to information to a specific principal (P-INFO) and agent information specific one or more specific agents (A-INFO) of said principal on said global computer network wherein said means for directing said user to said P-INFO comprises a connecting medium to said specific principal, wherein said connecting medium comprises a principal's identity (P-ID) specific to said specific principal;
(b) means for said specific principal to modify said P-INFO without modifying said external storage medium or said directional link medium such that said P-INFO comprises current information for said user of said external storage medium;
(c) means for each one said one or more specific agents to modify respective said A-INFO without modifying said external storage medium or said connecting medium or said P-INFO such that A-INFO of that modifying agent comprises current information for said user of said external storage medium; and
(d) a main database accessible via said external storage medium, said main database comprising one or more P-STORAGE identifiable to a specific one of said specific principal and which contains all of said P-INFO and all of said A-INFO.

31. The system as defined in claim 30 wherein each of said one or more P-STORAGE further comprises a password (P-PW) specific to said P-ID wherein said specific principal may modify said P-INFO by accessing said main database with said P-ID, by entering said P-PW into said main database and, if verified, said specific principal is granted access to said P-INFO for modification.

32. The system as defined in claim 30 wherein each one of said one or more P-STORAGE comprises one or more agent folder (A-STORAGE) and a respective specific agent identity (A-ID) to each one of said one or more A-STORAGE, said A-ID and said A-STORAGE corresponding to a specific agent of said one or more specific agents of said specific principal and that principal's respective said P-ID and said P-STORAGE.

33. The system as defined in claim 32 wherein each of said one or more A-STORAGE comprises an agent password (A-PW) specific to said A-ID and said A-INFO relative to a specific one of said one or more specific agents.

34. The system as defined in claim 30 further comprising means for said specific principal to modify said A-INFO without modifying said external storage medium or said connecting medium or said P-INFO.

35. The system as defined in claim 34 wherein said specific principal may modify said A-INFO by accessing said main database with said P-ID, by entering said A-ID and said P-PW into said main database and, if verified, said specific principal is granted access to said A-INFO for modification.
